(19) United States
(12) Patent Application Publication
(10) Pub. No.: US 2010/0120581 A1
(43) Pub. Date: May 13, 2010

(54) VEHICLE, CONTROL METHOD OF VEHICLE, AND DRIVING APPARATUS

(75) Inventors: Noritake Mitsutani, Toyota-shi (JP); Masahiro Nishiu, Toyohashi-shi (JP)

Correspondence Address: GIFFORD, KRASS, SPRINKLE,ANDERSON & CITKOWSKI, P.C, PO BOX 7021, TROY, MI, 48007-7021, US

(73) Assignees: Toyota Jidosha Kabushiki Kaisha, Toyota-Shi (JP); Aisin AW Co., Ltd., Anjo-Shi (JP)

(21) Appl. No.: 12/616,357

(22) Filed: Nov. 11, 2009

(30) Foreign Application Priority Data
Nov. 11, 2008 (JP) JP2008-288865

(51) Int. Cl. H02P 1/00; H02P 3/00

(52) U.S. Cl. 477/7

(57) ABSTRACT

Upon determination of the connection between the vehicle side connector 54 and the external power supply side connector 94 when the power switch 80 is switched on in the state of the vehicle system shut down, starting up the vehicle system is prohibited and the information that represents the vehicle driving is not possible due to the vehicle side connector 54 being connected to the external power supply 90 or the information that represents requiring disconnection of the vehicle side connector 54 from the external power supply 90 is provided. Upon determination of the connection between the vehicle side connector 54 and the external power supply side connector 94 in the state of the vehicle system started up in the driving mode, charging the high voltage battery 50 is not permitted and the information that represents the charge with the external power supply 90 is not possible due to the system of the hybrid vehicle 20 being started up in the driving mode or the information that represents requiring to switch off the power switch 80 is provided.

### BACKGROUND OF THE INVENTION

1. Field of the Invention

The present invention relates to a vehicle, a control method of the vehicle, and a driving apparatus. More specifically the invention pertains to a vehicle having a motor that outputs power for driving the vehicle, a control method of the vehicle, and a driving apparatus mounted in a vehicle along with an accumulator capable of charge and discharge.

2. Description of the Related Art

One proposed vehicle has a motor for driving drive wheels, a battery supplying electric power to the motor, a charging connector for connection with an external charger outside the vehicle in order to charge the battery, and a startup switch that is switched on according to a driver's operation (see, for example, Patent Document 1). This vehicle prohibits vehicle driving upon detection of connection between the charging connector and the external charger when the startup switch is switched on, and accordingly prevents the connector or cables from being broken at improper start of the vehicle driving when the driver forgets to disconnect a charging cable. This vehicle also prohibits the vehicle driving upon detection of the connection of the charging connector when the vehicle driving is permitted.

Patent Document 1: Japanese Patent Laid-Open No. H7-39012

### SUMMARY OF THE INVENTION

In this prior art vehicle, there is a case where the vehicle driving is prohibited and then the driver, who has an intention to start the vehicle driving, has a feeling of abnormality or inconvenience when the driver switches on the startup switch without recognizing that he or she forgets about disconnecting the charging cable. Such a feeling of abnormality or inconvenience is preferably to be reduced. The driver's feeling of abnormality or inconvenience is preferably to be reduced also upon detection of the connection of the charging connector when the vehicle driving is permitted.

In a vehicle, capable of charging an accumulator with electric power from a power supply outside the vehicle, a control method of the vehicle, and a driving apparatus according to the present invention, a main object is to reduce an operator's feeling of abnormality or inconvenience.

In order to attain at least the main object, a vehicle, a control method of the vehicle, and a driving apparatus of the present invention have the configurations discussed below.

According to one aspect, the present invention is directed to a first vehicle. The first vehicle, having a motor that outputs power for driving the vehicle, includes: an accumulator capable of supplying and receiving electric power to and from the motor; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; an informing unit that provides information; a connection determination module that determines whether or not the connection part of the charger is connected to the external power supply; and a shutdown time control module that, upon determination that the connection part of the charger is connected to the external power supply by the connection determination module when the startup instruction is given by the startup shutdown instruction unit in a state of the system of the vehicle shut down, controls the informing unit so as to provide information which represents driving the vehicle is impossible due to the connection part of the charger being connected to the external power supply and/or information which represents requiring disconnection of the connection part of the charger from the external power supply, without starting up the system of the vehicle.

The first vehicle according to this aspect of the invention, includes: a motor that outputs power for driving the vehicle; an accumulator capable of supplying and receiving electric power to and from the motor; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; and an informing unit that provides information. The first vehicle, upon determination that the connection part of the charger is connected to the external power supply when the startup instruction is given in a state of the system of the vehicle shut down, controls the informing unit so as to provide information which represents driving the vehicle is impossible due to the connection part of the charger being connected to the external power supply and/or information which represents requiring disconnection of the connection part of the charger from the external power supply, without starting up the system of the vehicle. This arrangement enables to reduce an operator's feeling of abnormality or inconvenience.

According to another aspect, the present invention is directed to a second vehicle. The second vehicle, having a motor that outputs power for driving the vehicle, includes: an accumulator capable of supplying and receiving electric power to and from the motor; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; an informing unit that provides information; a connection determination module that determines whether or not the connection part of the charger is connected to the external power supply; and a startup time control module that, upon determination that the connection part of the charger is connected to the external power supply by the connection determination module in a startup state defined as a state of the system of the vehicle being started up and driving the vehicle being possible, controls the informing unit so as to provide information which represents performing the external charge is impossible due to the system of the vehicle being started up and driving the vehicle being possible and/or information which represents requiring the shutdown instruction by the startup shutdown instruction unit, without performing the external charge.

The second vehicle according to this aspect of the invention, includes: a motor that outputs power for driving the vehicle, an accumulator capable of supplying and receiving electric power to and from the motor; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; and an informing unit that provides information. The second vehicle, upon determination that the connection part of the charger is connected to the external power supply in a startup state defined as a state of the system of the vehicle being started up and driving the vehicle is possible, controls the informing unit so as to provide information which represents performing the external charge is impossible due to the system of the vehicle being started up and driving the vehicle being possible and/or information which represents requiring the shutdown instruction by the startup shutdown instruction unit, without performing the external charge. This arrangement enables to reduce an operator's feeling of abnormality or inconvenience.

In one preferable application of the first vehicle of the invention, the connection determination module may be capable of determining a predetermined abnormality where it is impossible to normally determine whether or not the connection part of the charger is connected to the external power supply, and the shutdown time control module, upon determination of the predetermined abnormality when the startup instruction is given in the state of the system of the vehicle shut down, may control the informing unit so as to provide information which represents the predetermined abnormality. This arrangement enables to reduce an operator's feeling of abnormality or inconvenience caused by the predetermined abnormality.

In one preferable application of the second vehicle of the invention, the connection determination module may be capable of determining a predetermined abnormality where it is impossible to normally determine whether or not the connection part of the charger is connected to the external power supply, and the startup time control module, upon determination of the predetermined abnormality in the startup state, may control the informing unit so as to provide information which represents the predetermined abnormality. This arrangement enables to reduce an operator's feeling of abnormality or inconvenience caused by the predetermined abnormality.

In the application capable of determining the predetermined abnormality of the first or second vehicle of the invention, the connection determination module may be capable of detecting connection and disconnection of the connection part of the charger to and from the external power supply, and may determine that the connection part of the charger is connected to the external power supply when a predetermined time elapses in a state with detecting the connection of the connection part to the external power supply and without determining the predetermined abnormality. This arrangement enables to determine that the connection part of the charger is connected to the external power supply more appropriately.

In another preferable application of the second vehicle of the invention, may further include a vehicle halt state determination module that determines a vehicle halt state when a vehicle speed is less than a predetermined vehicle speed, and the startup time control module, upon determination of the vehicle halt state by the vehicle halt state determination module in addition to the determination that the connection part of the charger is connected to the external power supply by the connection determination module in the startup state, may control the informing unit so as to provide the information which represents performing the external charge is impossible due to the system of the vehicle being started up and driving the vehicle being possible and/or the information which represents requiring the shutdown instruction by the startup shutdown instruction unit, without performing the external charge. This arrangement enables to reduce an operator's feeling of abnormality or inconvenience when the connection part of the charger is connected to the external power supply by the operator in the vehicle halt state.

According to still another aspect, the present invention is directed to a first driving apparatus. The first driving apparatus, mounted in a vehicle along with an accumulator capable of charge and discharge, includes: a motor that outputs power for driving the vehicle and is capable of receiving and supplying electric power from and to the accumulator; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; an informing unit that provides information; a connection determination module that determines whether or not the connection part of the charger is connected to the external power supply; and a shutdown time control module that, upon determination that the connection part of the charger is connected to the external power supply by the connection determination module when the startup instruction is given by the startup shutdown instruction unit in a state of the system of the vehicle shut down, controls the informing unit so as to provide information which represents driving the vehicle is impossible due to the connection part of the charger being connected to the external power supply and/or information which represents requiring disconnection of the connection part of the charger from the external power supply, without starting up the system of the vehicle.

The first driving apparatus according to this aspect of the invention, includes: a motor that outputs power for driving the vehicle; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; and an informing unit that provides information. The first driving apparatus, upon determination that the connection part of the charger is connected to the external power supply when the startup instruction is given by the startup shutdown instruction unit in a state of the system of the vehicle shut down, controls the informing unit so as to provide information which represents driving the vehicle is impossible due to the connection part of the charger being connected to the external power supply and/or information which represents requiring disconnection of the connection part of the charger from the external power supply, without starting up the system of the vehicle. This arrangement enables to reduce an operator's feeling of abnormality or inconvenience.

According to still another aspect, the present invention is directed to a second driving apparatus. The second driving apparatus, mounted in a vehicle along with an accumulator capable of charge and discharge, includes: a motor that outputs power for driving the vehicle and is capable of receiving and supplying electric power from and to the accumulator; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; an informing unit that provides information; a connection determination module that determines whether or not the connection part of the charger is connected to the external power supply; and a startup time control module that, upon determination that the connection part of the charger is connected to the external power supply by the connection determination module in a startup state defined as a state of the system of the vehicle being started up and driving the vehicle is possible, controls the informing unit so as to provide information which represents performing the external charge is impossible due to the system of the vehicle being started up and driving the vehicle is possible and/or information which represents requiring the shutdown instruction by the startup shutdown instruction unit, without performing the external charge.

The second driving apparatus according to this aspect of the invention, includes: a motor that outputs power for driving the vehicle; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; and an informing unit that provides information. The second driving apparatus, upon determination that the connection part of the charger is connected to the external power supply in a startup state defined as a state of the system of the vehicle being started up and driving the vehicle is possible, controls the informing unit so as to provide information which represents performing the external charge is impossible due to the system of the vehicle being started up and driving the vehicle is possible and/or information which represents requiring the shutdown instruction by the startup shutdown instruction unit, without performing the external charge. This arrangement enables to reduce an operator's feeling of abnormality or inconvenience.

According to still another aspect, the present invention is directed to a first control method of a vehicle. The vehicle has: a motor that outputs power for driving the vehicle; an accumulator capable of supplying and receiving electric power to and from the motor; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; and an informing unit that provides information. The first control method, upon determination that the connection part of the charger is connected to the external power supply when the startup instruction is given by the startup shutdown instruction unit in a state of the system of the vehicle shut down, controls the informing unit so as to provide information which represents driving the vehicle is impossible due to the connection part of the charger being connected to the external power supply and/or information which represents requiring disconnection of the connection part of the charger from the external power supply, without starting up the system of the vehicle.

In the first control method of the vehicle according to this aspect of the invention, the vehicle has: a motor that outputs power for driving the vehicle; an accumulator capable of supplying and receiving electric power to and from the motor; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; and an informing unit that provides information. The first control method, upon determination that the connection part of the charger is connected to the external power supply when the startup instruction is given in a state of the system of the vehicle shut down, controls the informing unit so as to provide information which represents driving the vehicle is impossible due to the connection part of the charger being connected to the external power supply and/or information which represents requiring disconnection of the connection part of the charger from the external power supply, without starting up the system of the vehicle. This arrangement enables to reduce an operator's feeling of abnormality or inconvenience.

According to still another aspect, the present invention is directed to a second control method of a vehicle. The vehicle has: a motor that outputs power for driving the vehicle; an accumulator capable of supplying and receiving electric power to and from the motor; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; and an informing unit that provides information. The second control method, upon determination that the connection part of the charger is connected to the external power supply in a startup state defined as a state of the system of the vehicle being started up and driving the vehicle is possible, controls the informing unit so as to provide information which represents performing the external charge is impossible due to the system of the vehicle being started up and driving the vehicle is possible and/or information which represents requiring the shutdown instruction by the startup shutdown instruction unit, without performing the external charge.

In the second control method of the vehicle according to this aspect of the invention, the vehicle has: a motor that outputs power for driving the vehicle; an accumulator capable of supplying and receiving electric power to and from the motor; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; and an informing unit that provides information. The second control method, upon determination that the connection part of the charger is connected to the external power supply in a startup state defined as a state of the system of the vehicle being started up and driving the vehicle is possible, controls the informing unit so as to provide information which represents performing the external charge is impossible due to the system of the vehicle being started up and driving the vehicle is possible and/or information which represents requiring the shutdown instruction by the startup shutdown instruction unit, without performing the external charge. This arrangement enables to reduce an operator's feeling of abnormality or inconvenience.

### BRIEF DESCRIPTION OF THE DRAWINGS

FIG. 1 is a schematic illustration of the configuration of a hybrid vehicle 20 in one embodiment of the invention;

FIG. 2 is a flowchart showing a startup requiring control routine executed by a power supply ECU 78;

FIG. 3 is a flowchart showing a charge requiring control routine executed by the power supply ECU 78; and

FIG. 4 is a flowchart showing a connection determination routine executed by the power supply ECU 78.

### DESCRIPTION OF THE PREFERRED EMBODIMENTS

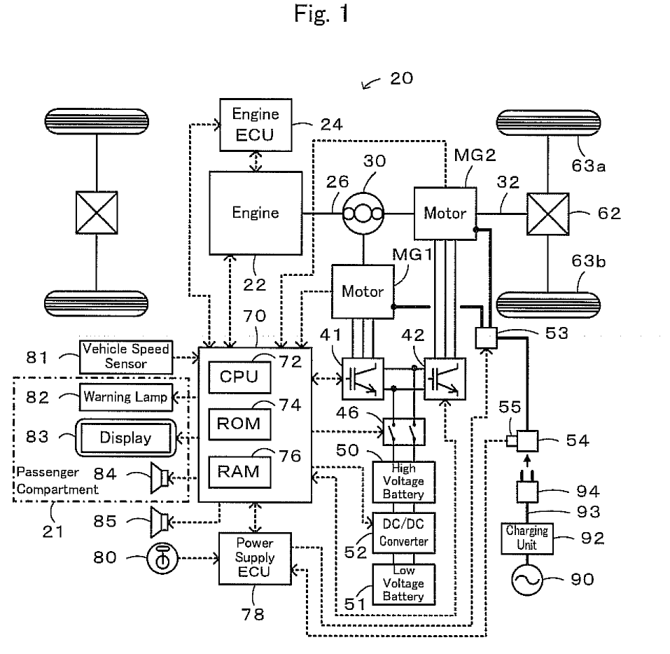

One mode of carrying out the invention is discussed below as a preferred embodiment. FIG. 1 is a schematic illustration of a hybrid vehicle 20 in one embodiment of the invention. As illustrated, the hybrid vehicle 20 of the embodiment includes: an engine 22 constructed as an internal combustion engine that outputs power, using hydrocarbon fuel such as gasoline or light oil, in response to operation controls such as fuel injection control, ignition control, and air flow regulation control by an engine electronic control unit (hereafter referred to as engine ECU) 24; a planetary gear mechanism 30 that carrier is connected via a damper to a crankshaft 26 or an output shaft of the engine 22; a motor MG1 constructed as a synchronous motor generator that rotor is connected to a sun gear of the planetary gear mechanism 30; a motor MG2 constructed as a synchronous motor generator that rotor is connected to a driveshaft 32 which is linked with a ring gear of the planetary gear mechanism 30 and with driving wheels 63a and 63b via a differential gear 62; inverters 41 and 42 configured as drive circuits to drive the motor MG1 and MG2; a high voltage battery 50 that is connected via a system main relay 46 to the inverters 41 and 42 and designed as a secondary battery supplying and receiving electric power to and from the motor MG1 and MG2; a DC/DC converter 52 that transforms electric power from the high voltage battery 50 to electric power of a lower voltage and supplies the electric power of the lower voltage to a low voltage battery 51; a hybrid electronic control unit (hereafter referred to as HVECU) 70 configured to control the operations of the whole hybrid vehicle 20; and a power supply electronic control unit (hereafter referred to as power supply ECU) 78 configured to function as a startup control device of the hybrid vehicle 20.

The high voltage battery 50 is a secondary battery such as a nickel metal hydride battery or a lithium-ion battery, and designed to have a capability to be charged with electric power from charging unit 92, outside the hybrid vehicle 20, that is connected to an external power supply 90 such as a domestic power supply (AC 100V). That is, the high voltage battery 50 is enabled to be charged with electric power from the external power supply 90 by switching control of the inverter 41 and 42 in a state that a relay included in an AC port 53 and the system main relay 46 are on and that a vehicle side connector 54 and an external power supply side connector 94 are connected. The vehicle side connector 54 is connected via the AC port 53 to the neutral point of the motor MG1 and MG2 (the neutral point of the multiphase windings), and the external power supply side connector 94 is attached to a charging cable 93 of the charging unit 92. This configuration allows the high voltage battery 50 to be charged with electric power from the external power supply 90 before starting the vehicle driving, and enables to start the vehicle driving with the high voltage battery 50 fully charged.

The HVECU 70 is constructed as a microprocessor including a CPU 72, a ROM 74 that stores processing programs, a RAM 76 that temporarily stores data, a non-illustrated input-output port, and a non-illustrated communication port. The HVECU 70 receives various inputs via the input port: a vehicle speed V from a vehicle speed sensor 81, a gearshift position SP from a gearshift position sensor (not shown) that detects the current position of a gearshift lever, an accelerator opening Acc from an accelerator pedal position sensor (not shown) that measures a step-on amount of an accelerator pedal, a brake pedal position BP from a brake pedal position sensor (not shown) that measures a step-on amount of a brake pedal, signals from rotational position detection sensors (not shown) that detect rotational positions of the rotors in the motors MG1 and MG2, phase currents applied to the motors MG1 and MG2 and measured by current sensors (not shown) attached to a power line from the inverters 41 and 42 to the motors MG1 and MG2, a charge-discharge current measured by a current sensor (not shown) attached near to an output terminal of the high voltage battery 50, an inter-terminal voltage measured by a voltage sensor (not shown) attached near to output terminals of the high voltage battery 50, and a battery temperature measured by a temperature sensor (not shown) attached to the high voltage battery 50. The HVECU 70 outputs various signals via the output port: the switching control signals to the inverters 41 and 42, an on/off signal to the system main relay 46, control signals to the DC/DC converter 52, a light-on signal to a warning lamp 82 attached near to a driver's seat in a passenger compartment 21, control signals for controlling display output of text and images to a display 83 attached near to the driver's seat in the passenger compartment 21, a control signal for controlling sound output from a speaker 84 that is driven by an amplifier (not shown) and located in the passenger compartment 21, and a control signal for controlling sound output from a speaker 85 that is driven by an amplifier (not shown) and outputs sound to outside the hybrid vehicle 20. The HVECU 70 communicates with the engine ECU 24 and the power supply ECU 78 via the communication port to transmit diverse control signals and data to and from the engine ECU 24 and the power supply ECU 78. The HVECU 70 of the embodiment also computes a remaining charge or state of charge (SOC) of the high voltage battery 50 from an integrated value of the charge-discharge current measured by the current sensor (not shown).

The power supply ECU 78 is operated with electric power supplied all the time from the low voltage battery 50 and constructed as a microprocessor including a non-illustrated CPU, a non-illustrated ROM that stores processing programs, a non-illustrated RAM that temporarily stores data, a non-illustrated input-output port, and a non-illustrated communication port. The power supply ECU 78 receives various inputs via the input port: an on/off signal from a power switch 80 that is attached to a panel in front of the driver's seat and gives an instruction for starting up a system of the hybrid vehicle 20 and an instruction for shutting down the system of the hybrid vehicle 20, and a detection signal from a connector sensor 55 that is attached to the vehicle side connector 54 for charging the high voltage battery 50 and detects whether the vehicle side connector 54 and the external power supply side connector 94 are connected or not. The power supply ECU 78 outputs various signals via the output port, for example, an on/off signal to the relay of the AC port 53. In the embodiment, the power supply ECU 78 controls a non-illustrated relay to be on so that electric power from the low voltage battery 51 is supplied to electronic control units such as the HVECU 70 and the engine ECU 24 upon reception of the on signal from the power switch 80 in a state of the system of the hybrid vehicle 20 shut down. The power supply ECU 78, upon further satisfaction of a predetermined startup condition, permits the system of the hybrid vehicle 20 started up in a driving mode that allows the vehicle driving, for example, by making the HVECU 70 control the system main relay 52 to be on. The power supply ECU 78 shuts down the system of the hybrid vehicle 20 upon satisfaction of a predetermined shutdown condition when the off signal from the power switch 80 is received in a state of the system of the hybrid vehicle 20 started up in the driving mode. In the embodiment, the power supply ECU 78 permits the system of the hybrid vehicle 20 started up in a charging mode, for example, by controlling the non-illustrated relay to be on so that electric power from the low voltage battery 51 is supplied to the HVECU 70, controlling the relay of the AC port 53 to be on, and making the HVECU 70 control the system main relay 52 to be on, upon determination that the vehicle side connector 54 and the external power supply side connector 94 are connected based on the detection signal from the connector sensor 55 in the state of the system of the hybrid vehicle 20 shut down. The power supply ECU 78 shuts down the system of the hybrid vehicle 20 when the high voltage battery 50 becomes fully charged in a state of the system of the hybrid vehicle 20 started up in the charging mode. The connector sensor 55 of the embodiment has a capability to output a connection signal Cn and a connection abnormality signal Cna as the detection signal. The connection signal Cn indicates whether there is a connection between the vehicle side connector 54 and the external power supply side connector 94 or not (on or off). The connection abnormality signal Cna indicates whether there is an abnormality where it is impossible to normally detect the connection between the vehicle side connector 54 and the external power supply side connector 94 or not (on or off), for example, a malfunction where the connection signal Cn is not able to be changed from on to off.

The hybrid vehicle 20 of the embodiment thus constructed calculates a torque demand to be output to the driveshaft 32 functioning as the drive shaft, based on observed values of a vehicle speed V and an accelerator opening Acc, which corresponds to a driver's step-on amount of the accelerator pedal. The engine 22 and the motors MG1 and MG2 are subjected to operation control to output a required level of power corresponding to the calculated torque demand to the driveshaft 32.

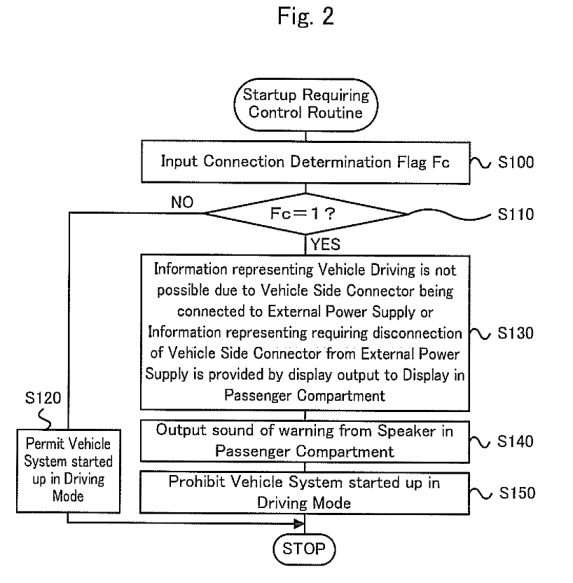

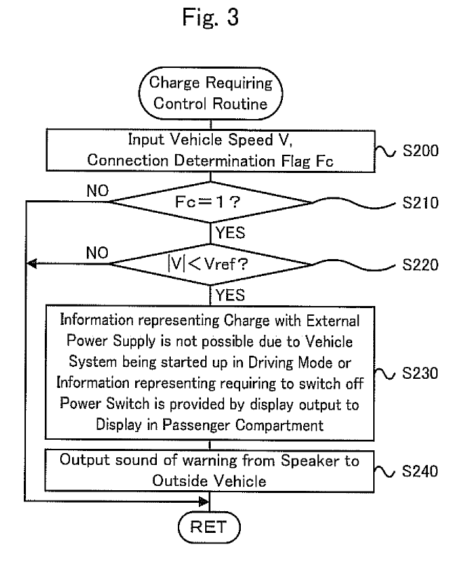

The description regards the operations of the hybrid vehicle 20 of the embodiment having the configuration discussed above, especially series of operation control when the driver switches on the power switch 80 and when the driver connects the external power supply side connector 94 of the charging cable 93 to the vehicle side connector 54. FIG. 2 is a flowchart showing a startup requiring control routine executed by the power supply ECU 78, and FIG. 3 is a flowchart showing a charge requiring control routine executed by the power supply ECU 78. The startup requiring control routine is performed when the on signal from the power switch 80 is received in the state of the system of the hybrid vehicle 20 shut down, and the charge requiring control routine is performed repeatedly at preset time intervals (for example, at every several msec) in the state of the system of the hybrid vehicle 20 started up in the driving mode. The startup requiring control is first described and the charge requiring control is next described. At the timing of start of performing the startup requiring control routine, the power supply ECU 78 controls the non-illustrated relay to be on so that electric power from the low voltage battery 51 is supplied to electronic control units such as the HVECU 70 based on the on signal from the power switch 80, regardless of permitting or prohibiting the system of the hybrid vehicle 20 stated up in the driving mode.

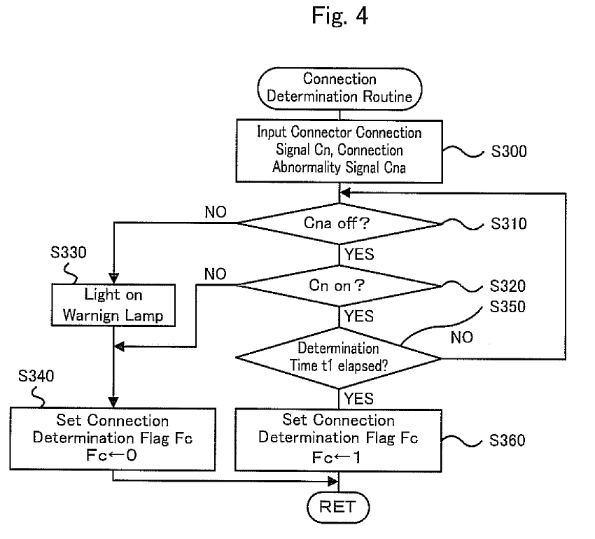

In the startup requiring control routine of FIG. 2, the CPU of the power supply ECU 78 inputs data required for control, for example, a connection determination flag Fc set in a connection determination routine shown in FIG. 4 (step S100). The description regarding the startup requiring control routine of FIG. 2 is suspended here, and the following description regards the processing of the connection determination executed by the power supply ECU 78. The connection determination routine is performed repeatedly at preset time intervals (for example, at every several msec), regardless of the state of the system of the hybrid vehicle 20 being started up or shut down.

In the connection determination routine of FIG. 4, the CPU of the power supply ECU 78 inputs the connection signal Cn and the connection abnormality signal Cna from the connector sensor 55 (step S300). The CPU determines whether the connection abnormality signal Cna is on or off (step S310), and determines whether the connection signal Cn is on or off (step S320). When the connection abnormality signal Cna is on, the CPU sends a command for lighting on the warming lamp 82 to the HVECU 70 in a case where the power switch 80 is on (step S330), sets the connection determination flag F to 0 (step S340), and terminates the connection determination routine. When the connection abnormality signal Cna is off and the connection signal Cn is off, the CPU sets the connection determination flag F to 0 (step S340), and terminates the connection determination routine. That is, the connection determination flag F is set to 0 in the both cases that a connection abnormality, where the connection between the vehicle side connector 54 and the external power supply side connector 94 is not able to be normally detected, is in occurrence and that the connector connection between the vehicle side connector 54 and the external power supply side connector 94 is not detected. The HVECU 70 receives the command from the power supply ECU 78, and lights on the warning lamp 82 in the passenger compartment 21. Accordingly, it is enabled to inform the driver of occurrence of abnormality. The warning lamp 82 is lighted up when the connection abnormality signal Cna is on at the start of performing the startup requiring control routine of FIG. 2, that is, at the input timing of the on signal from the power switch 80 in the state of the system of the hybrid vehicle 20 shut down. The warning lamp 82 is also lighted up when the connection abnormality signal Cna is on while performing the charge requiring control routine of FIG. 3, that is, the system of the hybrid vehicle 20 is started up in the driving mode.

When the connection abnormality signal Cna is off and the connection signal Cn is on, the CPU waits until a preset determination time t1 (for example, 50 msec or 100 msec) elapses without any change of the both signals (step S350). The CPU then sets the connection determination flag Fc to 1 (step S360), and terminates the connection determination routine. This arrangement of waiting until the preset determination time t1 elapses enables to determine the connection between the vehicle side connector 54 and the external power supply side 94 more appropriately, in comparison with an arrangement of making immediate determination of the connection between the vehicle side connector 54 and the external power supply side connector 94 when the connection is detected, and in comparison also with an arrangement of making immediate determination of the connection when the connection is detected while the connection abnormality is not in occurrence. The description above regards the processing of the connection determination.

The description regarding the startup requiring control routine of FIG. 2 is resumed here. After inputting the data such as the connection determination flag Fc, the CPU of the power supply ECU 78 checks the input connection determination flag Fc (step S110). When the connection determination flag Fc is 0, the CPU permits the system of the hybrid vehicle 20 started up in the driving mode (step S120), and terminates the startup requiring control routine. This control enables to drive the hybrid vehicle 20. When the connection determination flag Fc is 1, the CPU sends a command for display output of text to the display 83 to the HVECU 70 (step S130). The text gives information that represents driving the vehicle is impossible due to the vehicle side connector 54 being connected to the external power supply 90 (for example, “you can't drive the car because the charging cable is connected” or “the car system cannot be started up because the charging cable is connected”), or the text gives information that represents requiring disconnection of the vehicle side connector 54 from the external power supply 90 (for example, “please disconnect the charging cable because the you can't drive the car” or “please disconnect the charging cable because the car system can't be started up”). The CPU also sends a command for sound output of warning from the speaker 84 in the passenger compartment 21 to the HVECU 70 (step S140). The CPU then prohibits the system of the hybrid vehicle 20 started up in the driving mode (step S150), and terminates the startup requiring control routine. As described above, upon determination of the connector connection between the vehicle side connector 54 and the external power supply side connector 94 when the power switch 80 is switched on in the state of the vehicle system shut down, the HVECU 70 receives a command from the power supply ECU 78 and provides the above information by display output of text to the display 83 in the passenger compartment 21 and sound output of warning from the speaker 84. This arrangement accordingly reduces the driver's feeling of abnormality or inconvenience that is caused because the vehicle driving cannot be started when the driver switches on the power switch 80 without recognizing he or she forgets about disconnecting the charging cable 93. The above information is provided according to the connection determination flag Fc set when the preset determination time t1 elapses in the state with detecting the connector connection and without occurrence of the connection abnormality, the connector connection is accordingly determined more appropriately, for example, with reduction of providing erroneous information. This arrangement thus reduces the driver's feeling of abnormality or inconvenience more appropriately. The description above regards the startup requiring control.

In the charge requiring control routine of FIG. 3, the CPU of the power supply ECU 78 inputs data required for control, for example, the vehicle speed V and the connection determination flag Fc set in the connection determination routine of FIG. 4 (step S200). The vehicle speed V is measured by the vehicle speed sensor 81 and input from the HVECU 70 by communication.

After the data input, the CPU checks the input connection determination flag Fc (step S210), and determines whether the absolute value of the input vehicle speed V is less than the preset vehicle speed Vref (for example, 5 km/h or 3 km/h) for determination of the vehicle halt state (step S220). When the connection determination flag Fc is 0, that is, in the both cases that the connection abnormality, where the connection between the vehicle side connector 54 and the external power supply side connector 94 is not able to be normally detected, is in occurrence and that the connector connection between the vehicle side connector 54 and the external power supply side connector 94 is not detected, the CPU terminates the charge requiring control routine. Upon no determination of the vehicle halt state when the vehicle speed V is not less than the preset vehicle speed Vref although the connection determination flag Fc is 1, the CPU decides there is not such a case where the charging cable 94 is connected to the vehicle side during the vehicle driving, then terminates the charge requiring control routine. In these cases, the hybrid vehicle 20 maintains the state of driving enabled.

On the other hand, upon determination of the vehicle halt state when the vehicle speed V is less than the preset vehicle speed Vref while the connection determination flag Fc is 1, the CPU sends a command for display output of text to the display 83 to the HVECU 70 (step S230). The text gives information that represents charging with the external power supply 90 is not possible due to the system of the hybrid vehicle 20 being started up in the driving mode (for example, “the battery can't be charged because the power switch is still on” or “the battery can't be charged because the vehicle system is still started up”), or the text gives information that represents requiring to switch off the power switch 80 (for example, “please switch off the power switch because the battery can't be charged” or “please connect the charging cable after switching off the power switch”). The CPU also sends a command for sound output of warning from the speaker 85 to the outside the hybrid vehicle 20 (step S240). The CPU then terminates the charge requiring control routine. As described above, upon determination of the connector connection between the vehicle side connector 54 and the external power supply side connector 94 in the vehicle halt state and the state of the vehicle system started up in the driving mode, the HVECU 70 receives a command from the power supply ECU 78 and provides the above information by display output of text to the display 83 in the passenger compartment 21 and sound output of warning from the speaker 85 to the outside the vehicle. This arrangement accordingly reduces the driver's or operator's feeling of abnormality or inconvenience that is caused because the driver or operator does not recognize the situation where the charge of the high voltage battery 50 with electric power supplied from the external power supply 90 cannot be started due to the power switch 80 being on. The above information is provided according to the connection determination flag Fc set when the preset determination time t1 elapses in the state with detecting the connector connection and without occurrence of the connection abnormality, the connector connection is accordingly determined more appropriately, for example, with reduction of providing erroneous information. This arrangement thus reduces the driver's or operator's feeling of abnormality or inconvenience more appropriately. The above information is provided upon determination of the vehicle halt state in addition to determination of the connector connection between the vehicle side connector 54 and the external power supply side connector 94. This arrangement thus reduces the driver's or operator' s feeling of abnormality or inconvenience further appropriately.

In the hybrid vehicle 20 of the embodiment described above, upon determination of the connection between the vehicle side connector 54 and the external power supply side connector 94 when the power switch 80 is switched on in the state of the vehicle system shut down, starting up the vehicle system is prohibited and the information that represents the vehicle driving is not possible due to the vehicle side connector 54 being connected to the external power supply 90 or the information that represents requiring disconnection of the vehicle side connector 54 from the external power supply 90 is provided. This arrangement effectively reduces the driver's feeling of abnormality or inconvenience. In the hybrid vehicle 20 of the embodiment, upon determination of the connection between the vehicle side connector 54 and the external power supply side connector 94 in the state of the vehicle system started up in the driving mode, charging the high voltage battery 50 is not permitted and the information that represents the charge with the external power supply 90 is not possible due to the system of the hybrid vehicle 20 being started up in the driving mode or the information that represents requiring to switch off the power switch 80 is provided. This arrangement effectively reduces the driver's or operator's feeling of abnormality or inconvenience.

In the hybrid vehicle 20 of the embodiment, upon determination of the connection between the vehicle side connector 54 and the external power supply side connector 94 when the power switch 80 is switched on in the state of the vehicle system shut down, either one of the information that represents the vehicle driving is not possible due to the vehicle side connector 54 being connected to the external power supply 90 or the information that represents requiring disconnection of the vehicle side connector 54 from the external power supply 90 is provided. However, upon the determination, both of the information that represents the vehicle driving is not possible due to the vehicle side connector 54 being connected to the external power supply 90 and the information that represents requiring disconnection of the vehicle side connector 54 from the external power supply 90 may be provided.

In the hybrid vehicle 20 of the embodiment, upon determination of the connection between the vehicle side connector 54 and the external power supply side connector 94 in the state of the vehicle system started up in the driving mode, either one of the information that represents the charge with the external power supply 90 is not possible due to the system of the hybrid vehicle 20 being started up in the driving mode or the information that represents requiring to switch off the power switch 80 is provided. However, upon the determination, both of the information that represents the charge with the external power supply 90 is not possible due to the system of the hybrid vehicle 20 being started up in the driving mode and the information that represents requiring to switch off the power switch 80 may be provided.

In the hybrid vehicle 20 of the embodiment, upon determination of the connection between the vehicle side connector 54 and the external power supply side connector 94 when the power switch 80 is switched on in the state of the vehicle system shut down, information is provided by display output of text to the display 83 in the passenger compartment 21 and sound output of warning from the speaker 84. However, upon the determination, information may be provided only by display output of text to the display 83, information may be provided by sound output of a message from the speaker 84 in place of or in addition to these, information may be provided by display output of an image such as an icon in place of or in addition to these, and information may be provided together with lighting on the warming lamp 82 in addition to these.

In the hybrid vehicle 20 of the embodiment, upon determination of the connection between the vehicle side connector 54 and the external power supply side connector 94 in the state of the vehicle system started up in the driving mode, information is provided by display output of text to the display 83 in the passenger compartment 21 and sound output of warning from the speaker 85 to the outside the vehicle. However, upon the determination, information may be provided by display output of an image such as an icon, information may be provided by sound output of a message from the speaker 85 to the outside the vehicle in place of or in addition to these, information may be provided together with lighting on the warming lamp 82 in addition to these, and information may be provided with flashing on and off a non-illustrated emergency lamp (for example, all of directional indicators).

In the hybrid vehicle 20 of the embodiment, the warning lamp 82 is lighted up when the connection abnormality signal Cna is on. However, in place of lighting up the warning lamp 82, information that represents occurrence of a connection abnormality where it is impossible to normally detect the connection between the vehicle side connector 54 and the external power supply side connector 94 (for example, “The charging connector is in an abnormal condition”) may be provided by display output of text to the display 83 in the passenger compartment 21 and sound output of a message from the speaker 84 when the connection abnormality signal Cna is on. The warning lamp 82 may not be lighted up even when the connection abnormality signal Cna is on.

In the hybrid vehicle 20 of the embodiment, the connector sensor 55 has a capability to output a connection signal Cn and a connection abnormality signal Cna as the detection signal. However, the connector sensor 55 may output only the connection signal Cn. In this case, without executing the connection determination routine of FIG. 4, input of the connection signal Cn from the connector sensor 55 and determination whether the connection signal Cn is on or off may be performed in place of the processing of step S100 and S110 in the startup requiring control routine of FIG. 2 and also the processing of step S200 and S210 in the charge requiring control routine of FIG. 3.

In the hybrid vehicle 20 of the embodiment, the high voltage battery 50 is enabled to be charged with electric power from the external power supply 90 by switching control of the inverter 41 and 42 in the state that the relay included in the AC port 53 and the system main relay 46 are on and that the vehicle side connector 54, which is connected via the AC port 53 to the neutral point of the motor MG1 and MG2 (the neutral point of the multiphase windings), and the external power supply 90 are connected. However, the high voltage battery 50 may be charged with electric power from the external power supply 90 by controlling a charging circuit, which has a vehicle side connector 54 and is electrically connected to the high voltage battery 50, in a stage that the vehicle side connector 54 and the external power supply side connector 94 are connected.

In the hybrid vehicle 20 of the embodiment, the engine 22 and the motor MG1 are connected to the driveshaft 32 via the planetary gear mechanism 30. The technique of the invention is also applicable to a hybrid vehicle that has an engine and a motor both connected to the driveshaft without having the motor MG1, or a hybrid vehicle that has a capability of charging a battery with electric power generated by a generator using all of output power from an engine and a capability of driving the vehicle with output power from a motor using the electric power from the battery, and also applicable to an electric vehicle that is driven with output power from a motor connected to a battery which is chargeable and dischargeable.

The technique of the invention is not restricted to the motor vehicle but may be actualized by any other diverse applications, for example, a vehicle other than motor vehicles such as a train, and a driving apparatus mounted in a vehicle along with the high voltage battery 50, as well as a control method of a vehicle.

The primary elements in the embodiment and its modified examples are mapped to the primary constituents in the claims of the invention as described below. The motor MG2 in the embodiment corresponds to the ‘motor’ in the claims of the invention. The high voltage battery 50 in the embodiment corresponds to the ‘accumulator’ in the claims of the invention. The vehicle side connector 54 in the embodiment corresponds to the ‘connection part’ in the claims of the invention. The combination of the system main relay 46, the inverter 41 and 42, the motor MG1 and MG2, the AC port 53, and the vehicle side connector 54 in the embodiment corresponds to the ‘charger’ in the claims of the invention. The power switch 80 in the embodiment corresponds to the ‘startup shutdown instruction unit’ in the claims of the invention. The combination of the warning lamp 82, the display 83, the speaker 84, and the speaker 85 in the embodiment corresponds to the ‘informing unit’ in the claims of the invention. The combination of the connector sensor 55, which outputs the connection signal Cn and the connection abnormality signal Cna as the detection signal, and the power supply ECU 78 in the embodiment corresponds to the ‘connection determination module’ in the claims of the invention. The power supply ECU 78 executes the connection determination routine of FIG. 4 that sets the connection determination flag Fc to 1 when the preset determination time t1 elapses in the state of the connection abnormality signal Cna being off and the connection signal Cn being on, and also executes the processing of step S110 in the startup requiring control routine of FIG. 2 and the processing of step S210 in the charge requiring control routine of FIG. 3 to make determination of the connection determination flag Fc. The combination of the power supply ECU 78 and the HVECU 70 in the embodiment corresponds to the ‘shutdown time control module’ in the claims of the invention. The power supply ECU 78, upon determination of the connection determination flag Fc being 1 when the power switch 80 is switched on in the state of the vehicle system shut down, executes the startup requiring control routine of FIG. 2 in which an instruction to HVECU 70 is given to prohibit starting up the vehicle system and to provide the information that represents the vehicle driving is not possible due to the vehicle side connector 54 being connected to the external power supply 90 or the information that represents requiring disconnection of the vehicle side connector 54 from the external power supply 90. The HVECU 70, upon reception of the instruction, controls the display output to the display 83 and the sound output from the speaker 84 so that the information is provided. The combination of the power supply ECU 78 and the HVECU 70 in the embodiment corresponds to the ‘startup time control module’ in the claims of the invention. The power supply ECU 78, upon determination of the connection determination flag Fc being 1 in the state of the vehicle system started up in the driving mode, executes the charge requiring control routine of FIG. 3 in which an instruction is given to the HVECU 70 not to permit charging the high voltage battery 50 and to provide the information that represents the charge with the external power supply 90 is not possible due to the system of the hybrid vehicle 20 being started up in the driving mode or the information that represents requiring to switch off the power switch 80. The HVECU 70, upon reception of the instruction, controls the display output to the display 83 and the sound output from the speaker 85 so that the information is provided.

The ‘motor’ is not restricted to the motor MG2 constructed as a synchronous motor generator, but may be any type of motor constructed to output power for driving the vehicle, for example, an induction motor. The ‘accumulator’ is not restricted to the high voltage battery 50 designed as a secondary battery, but may be a capacitor or any other storage unit capable of supplying and receiving electric power to and from the motor. The ‘connection part’ is not restricted to the vehicle side connector 54, but may be any other part that is connected to an external power supply defined as a power supply outside the vehicle. The ‘charger’ is not restricted to the combination of the system main relay 46, the inverter 41 and 42, the motor MG1 and MG2, the AC port 53, and the vehicle side connector 54, but may be any other arrangement having a connection part that is connected to an external power supply defined as a power supply outside the vehicle, and capable of performing an external charge defined as charging the accumulator with electric power from the external power supply when the connection part is connected to the external power supply, for example, a charging circuit connected to the high voltage battery 50. The ‘connection determination module’ is not restricted to the combination of the connector sensor 55, which outputs the connection signal Cn and the connection abnormality signal Cna as the detection signal, and the power supply ECU 78, where the power supply ECU 78 that sets the connection determination flag Fc to 1 when the preset determination time t1 elapses in the state of the connection abnormality signal Cna being off and the connection signal Cn being on and also makes determination of the connection determination flag Fc, but may be any other arrangement that determines whether or not the connection part of the charger is connected to the external power supply, for example, a sensor that outputs only the connector connection signal Cn as a detection signal. The ‘startup shutdown instruction unit’ is not restricted to the power switch 80, but may be any other unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible. The ‘informing unit’ is not restricted to the combination of the warning lamp 82, the display 83, the speaker 84, and the speaker 85, but may be a single display or any other unit that provides information. The ‘shutdown time control module’ is not restricted to the combination of the power supply ECU 78 and the HVECU 70, but may be actualized by a single electronic control unit. The ‘shutdown time control module’ is not restricted to the arrangement that, upon determination of the connection determination flag Fc being 1 when the power switch 80 is switched on in the state of the vehicle system shut down, prohibits starting up the vehicle system and provides the information that represents the vehicle driving is not possible due to the vehicle side connector 54 being connected to the external power supply 90 or the information that represents requiring disconnection of the vehicle side connector 54 from the external power supply 90 by the display output to the display 83 and the sound output from the speaker 84, but may be any other arrangement that, upon determination that the connection part of the charger is connected to the external power supply by the connection determination module when the startup instruction is given by the startup shutdown instruction unit in a state of the system of the vehicle shut down, controls the informing unit so as to provide information which represents driving the vehicle is impossible due to the connection part of the charger being connected to the external power supply and/or information which represents requiring disconnection of the connection part of the charger from the external power supply, without starting up the system of the vehicle. The ‘startup time control module’ is not restricted to the combination of the power supply ECU 78 and the HVECU 70, but may be actualized by a single electronic control unit. The ‘startup time control module’ is not restricted to the arrangement that, upon determination of the connection determination flag Fc being 1 in the state of the vehicle system started up in the driving mode, does not permit charging the high voltage battery 50 and provides the information that represents the charge with the external power supply 90 is not possible due to the system of the hybrid vehicle 20 being started up in the driving mode or the information that represents requiring to switch off the power switch 80 by the display output to the display 83 and the sound output from the speaker 85, but may be any other arrangement that, upon determination that the connection part of the charger is connected to the external power supply by the connection determination module in a startup state defined as a state of the system of the vehicle being started up and driving the vehicle being possible, controls the informing unit so as to provide information which represents performing the external charge is impossible due to the system of the vehicle being started up and driving the vehicle being possible and/or information which represents requiring the shutdown instruction by the startup shutdown instruction unit, without performing the external charge.

The above mapping of the primary elements in the embodiment and its modified examples to the primary constituents in the claims of the invention is not restrictive in any sense but is only illustrative for concretely describing the modes of carrying out the invention. Namely the embodiment and its modified examples discussed above are to be considered in all aspects as illustrative and not restrictive.

There may be many modifications, changes, and alterations without departing from the scope or spirit of the main characteristics of the present invention.

The technique of the invention is preferably applied to the manufacturing industries of vehicles and driving apparatuses.

The disclosure of Japanese Patent Application No. 2008-288865 filed on Nov. 11, 2008 including specification, drawings and claims is incorporated herein by reference in its entirety.

What is claimed is:

1. A vehicle having a motor that outputs power for driving the vehicle, the vehicle comprising:
an accumulator capable of supplying and receiving electric power to and from the motor;
a charger having a connection part that is connected to an external power supply defined as a power supply outside the vehicle, and capable of performing an external charge defined as charging the accumulator with electric power from the external power supply when the connection part is connected to the external power supply;
a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible;
an informing unit that provides information;
a connection determination module that determines whether or not the connection part of the charger is connected to the external power supply; and
a shutdown time control module that, upon determination that the connection part of the charger is connected to the external power supply by the connection determination module when the startup instruction is given by the startup shutdown instruction unit in a state of the system of the vehicle shut down, controls the informing unit so as to provide information which represents driving the vehicle is impossible due to the connection part of the charger being connected to the external power supply and/or information which represents requiring disconnection of the connection part of the charger from the external power supply, without starting up the system of the vehicle.

2. The vehicle according to claim 1, wherein the connection determination module is capable of determining a predetermined abnormality where it is impossible to normally determine whether or not the connection part of the charger is connected to the external power supply, and
the shutdown time control module, upon determination of the predetermined abnormality when the startup instruction is given in the state of the system of the vehicle shut down, controls the informing unit so as to provide information which represents the predetermined abnormality.

3. The vehicle according to claim 2, wherein the connection determination module is capable of detecting connection and disconnection of the connection part of the charger to and from the external power supply, and determines that the connection part of the charger is connected to the external power supply when a predetermined time elapses in a state with detecting the connection of the connection part to the external power supply and without determining the predetermined abnormality.

4. A vehicle having a motor that outputs power for driving the vehicle, the vehicle comprising:
an accumulator capable of supplying and receiving electric power to and from the motor;
a charger having a connection part that is connected to an external power supply defined as a power supply outside the vehicle, and capable of performing an external charge defined as charging the accumulator with electric power from the external power supply when the connection part is connected to the external power supply;
a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible;
an informing unit that provides information;
a connection determination module that determines whether or not the connection part of the charger is connected to the external power supply; and
a startup time control module that, upon determination that the connection part of the charger is connected to the external power supply by the connection determination module in a startup state defined as a state of the system of the vehicle being started up and driving the vehicle being possible, controls the informing unit so as to provide information which represents performing the external charge is impossible due to the system of the vehicle being started up and driving the vehicle being possible and/or information which represents requiring the shutdown instruction by the startup shutdown instruction unit, without performing the external charge.

5. The vehicle according to claim 4, wherein the connection determination module is capable of determining a predetermined abnormality where it is impossible to normally determine whether or not the connection part of the charger is connected to the external power supply, and
the startup time control module, upon determination of the predetermined abnormality in the startup state, controls the informing unit so as to provide information which represents the predetermined abnormality.

6. The vehicle according to claim 5, wherein the connection determination module is capable of detecting connection and disconnection of the connection part of the charger to and from the external power supply, and determines that the connection part of the charger is connected to the external power supply when a predetermined time elapses in a state with detecting the connection of the connection part to the external power supply and without determining the predetermined abnormality.

7. The vehicle according to claim 4, further comprising:
a vehicle halt state determination module that determines a vehicle halt state when a vehicle speed is less than a predetermined vehicle speed;
wherein the startup time control module, upon determination of the vehicle halt state by the vehicle halt state determination module in addition to the determination that the connection part of the charger is connected to the external power supply by the connection determination module in the startup state, controls the informing unit so as to provide the information which represents performing the external charge is impossible due to the system of the vehicle being started up and driving the vehicle being possible and/or the information which represents requiring the shutdown instruction by the startup shutdown instruction unit, without performing the external charge.

8. A driving apparatus mounted in a vehicle along with an accumulator capable of charge and discharge, the driving apparatus comprising:
a motor that outputs power for driving the vehicle and is capable of receiving and supplying electric power from and to the accumulator;
a charger having a connection part that is connected to an external power supply defined as a power supply outside the vehicle, and capable of performing an external charge defined as charging the accumulator with electric power from the external power supply when the connection part is connected to the external power supply;
a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible;
an informing unit that provides information;
a connection determination module that determines whether or not the connection part of the charger is connected to the external power supply; and
a shutdown time control module that, upon determination that the connection part of the charger is connected to the external power supply by the connection determination module when the startup instruction is given by the startup shutdown instruction unit in a state of the system of the vehicle shut down, controls the informing unit so as to provide information which represents driving the vehicle is impossible due to the connection part of the charger being connected to the external power supply and/or information which represents requiring disconnection of the connection part of the charger from the external power supply, without starting up the system of the vehicle.

9. A driving apparatus mounted in a vehicle along with an accumulator capable of charge and discharge, the driving apparatus comprising:
a motor that outputs power for driving the vehicle and is capable of receiving and supplying electric power from and to the accumulator;
a charger having a connection part that is connected to an external power supply defined as a power supply outside the vehicle, and capable of performing an external charge defined as charging the accumulator with electric power from the external power supply when the connection part is connected to the external power supply;
a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible;
an informing unit that provides information;
a connection determination module that determines whether or not the connection part of the charger is connected to the external power supply; and
a startup time control module that, upon determination that the connection part of the charger is connected to the external power supply by the connection determination module in a startup state defined as a state of the system of the vehicle being started up and driving the vehicle being possible, controls the informing unit so as to provide information which represents performing the external charge is impossible due to the system of the vehicle being started up and driving the vehicle is possible and/or information which represents requiring the shutdown instruction by the startup shutdown instruction unit, without performing the external charge.

10. A control method of a vehicle, the vehicle having: a motor that outputs power for driving the vehicle; an accumulator capable of supplying and receiving electric power to and from the motor; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; and an informing unit that provides information,
the control method, upon determination that the connection part of the charger is connected to the external power supply when the startup instruction is given by the startup shutdown instruction unit in a state of the system of the vehicle shut down, controlling the informing unit so as to provide information which represents driving the vehicle is impossible due to the connection part of the charger being connected to the external power supply and/or information which represents requiring disconnection of the connection part of the charger from the external power supply, without starting up the system of the vehicle.

11. A control method of a vehicle, the vehicle having: a motor that outputs power for driving the vehicle; an accumulator capable of supplying and receiving electric power to and from the motor; a charger having a connection part that is connected to an external power supply defined as a power supply outside the vehicle, and capable of performing an external charge defined as charging the accumulator with electric power from the external power supply when the connection part is connected to the external power supply; a startup shutdown instruction unit that gives a startup instruction and a shutdown instruction, the startup instruction being an instruction for starting up a system of the vehicle so that driving the vehicle becomes possible and the shutdown instruction being an instruction for shutting down the system of the vehicle so that driving the vehicle becomes impossible; and an informing unit that provides information,
the control method, upon determination that the connection part of the charger is connected to the external power supply in a startup state defined as a state of the system of the vehicle being started up and driving the vehicle is possible, controlling the informing unit so as to provide information which represents performing the external charge is impossible due to the system of the vehicle being started up and driving the vehicle is possible and/or information which represents requiring the shutdown instruction by the startup shutdown instruction unit, without performing the external charge.
